(19) United States
(12) Patent Application Publication
(10) Pub. No.: US 2010/0321293 A1
(43) Pub. Date: Dec. 23, 2010

(54) COMMAND GENERATION METHOD AND COMPUTER USING THE SAME

(75) Inventor: Chan-Yee Hsiung, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: SONIX TECHNOLOGY CO., LTD., Hsinchu (TW)

(21) Appl. No.: 12/652,750

(22) Filed: Jan. 6, 2010

(30) Foreign Application Priority Data
Jun. 17, 2009 (TW) 98120250

(51) Int. Cl. G06F 3/033; H04N 7/18

(52) U.S. Cl. 345/158; 348/77; 348/E07.085

(57) ABSTRACT

A command generation method is suitable for a computer. First, a human body image is captured by an image capturing device in a two-dimensional image form. Then, the shape of the human body image is determined in two-dimensional image recognition for obtaining a determined result. A command is generated according to the determined result.

### CROSS-REFERENCE TO RELATED APPLICATION

This application claims the priority benefit of Taiwan application serial no. 98120250, filed Jun. 17, 2009. The entirety of the above-mentioned patent application is hereby incorporated by reference herein and made a part of specification.

### BACKGROUND OF THE INVENTION

1. Field of the Invention

The present invention relates to a command generation method, and more particularly to a command generation method suitable for a computer.

2. Description of Related Art

With the advancement of computer technology, the popularity of computer operating systems has greatly increased, and computer operating systems have become indispensable tools for modern people in their daily lives. By executing various applications, a computer operating system not only helps the user to rapidly process documents, but also has functions such as playing multimedia files, browsing the interne, or storing data.

In general, when using the operating system, the user mostly needs to perform directional operations through a human-machine interface, so as to open a file or execute a function. Currently, some of the most widely used human-machine interfaces include keyboards, mice, and touch pads. However, whether using keyboards, mice, or touch pads, direct contact with the user is required for operation.

### SUMMARY OF THE INVENTION

The invention provides a command generation method, wherein the user is capable of generating commands without contacting a keyboard, mouse, or touch pad.

An embodiment of the invention provides a command generation method suitable for a computer. First, a human body image is captured by an image capturing device in a two-dimensional image form. Then, the shape of the human body image is determined by two-dimensional image reorganization for obtaining a determined result. A command is generated according to the determined result.

In light of the above, according to the above embodiment of the invention, the human body image is captured by the image capturing device, and the command is generated according to the determined result of the human body image, so that the user is able to input the command without contacting the keyboard, mouse, or touch pad.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a command generation method according to an embodiment of the invention.

FIG. 2 is a flowchart illustrating a command generation method according to another embodiment of the invention.

FIGS. 3A to 3F are schematic diagrams of human body images in FIG. 2.

FIG. 4 is a diagram illustrating a computer according to still another embodiment of the invention.

### DESCRIPTION OF EMBODIMENTS

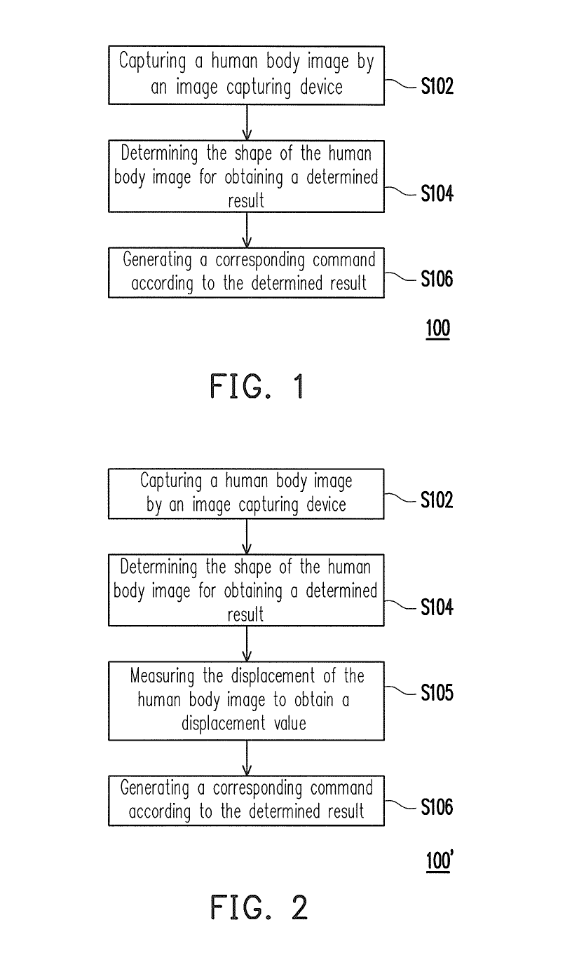

FIG. 1 is a flowchart illustrating a command generation method according to an embodiment of the invention. Referring to FIG. 1, a command generation method 100 is suitable for a computer, for example a desktop personal computer (PC) or a notebook PC, and is implemented in the computer as a software or firmware. A computer operating system, such as a Microsoft Windows operating system, is installed in the computer. In addition, the desktop computer includes a host and a display, wherein the host and the display are electrically connected with each other and integrated as a single unit or are two individual parts.

First, a human body image is captured by an image capturing device (step S102), wherein the image capturing device is a built-in component or an external component with respect to the computer. Then, the shape of the human body image is determined for obtaining a determined result (step 104). A corresponding command is generated according to the determined result (step S106). In detail, the image capturing device is capable of capturing the image of the user in a two-dimensional image form, the image which is captured according to a pre-set software is determined in two-dimensional image recognition, and the corresponding command is generated into the computer according to the determined result, so as to perform a specific function of the computer operating system.

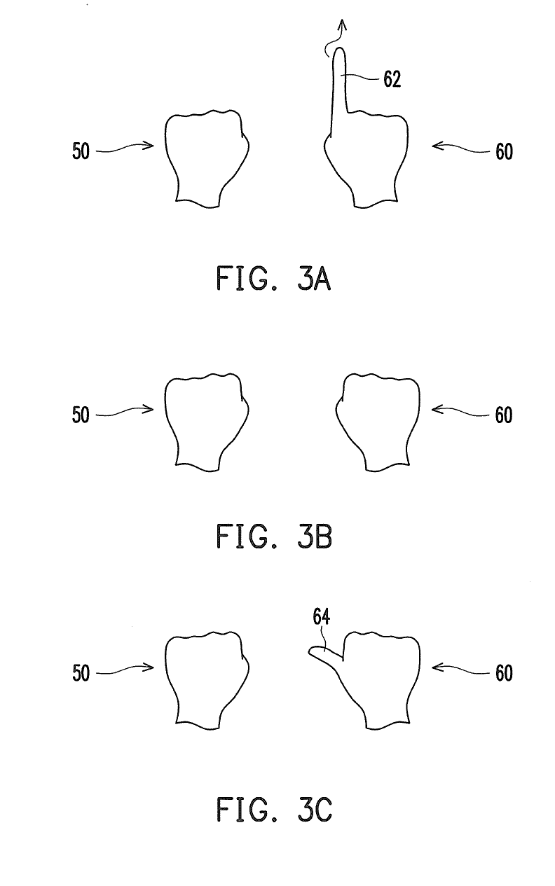

Further, the specific function of the computer operating system is, for example, moving a cursor displayed on the display, clicking a left button or right button of the mouse, inputting a character, or turning pages. Detailed explanations are given below. FIG. 2 is a flowchart illustrating a command generation method according to another embodiment of the invention. Referring to FIG. 2, compared with the command generation method 100 in FIG. 1, a command generation method 100′ is capable of further measuring a displacement between the human body images to obtain a displacement value (step S105) between the step S104 and the step S106, so that the displacement value is used as a basis for subsequently generating the command. In detail, the method for measuring the displacement between the human body images to obtain the displacement value includes, for example, comparing the human body images captured at different time points by the image capturing device, so that the above displacement value is obtained according to the relative positions of these human body images. For example, the image capturing device is capable of capturing five human body images every second and obtaining the displacement value in every second according to the relative positions of the human body images.

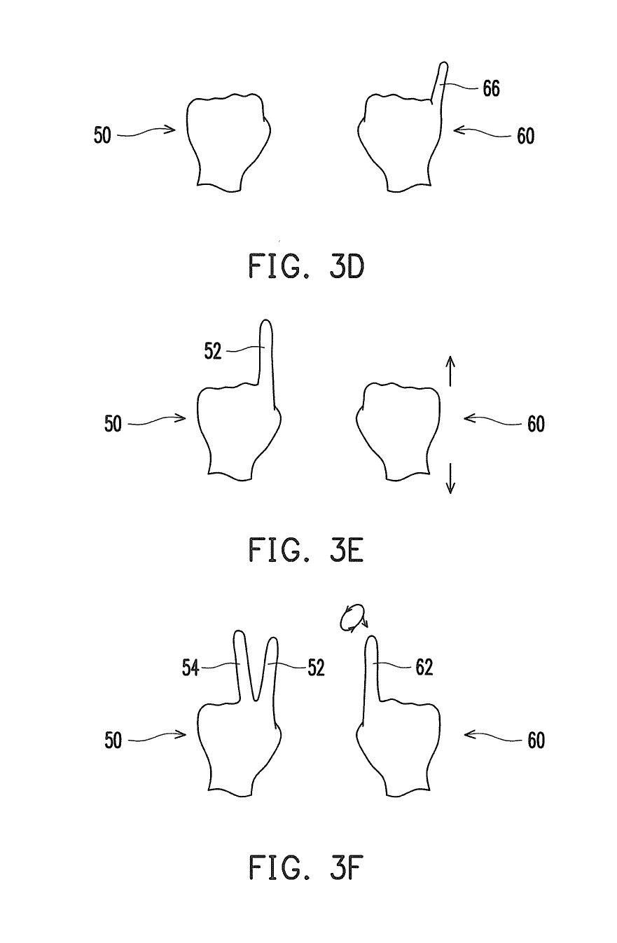

FIGS. 3A to 3F are schematic diagrams of human body images in FIG. 2. According to the present embodiment, images of the two hands of the user are exemplarily used as a basis for generating the command. For example, the software installed in the computer operating system and corresponding to the command generation method 100′ may be set as follows:

If the image capturing device captures images in which a left hand 50 makes a first and a right hand 60 sticks out an index finger 62 and moves (as shown in FIG. 3A), the displacement of the index finger 62 of the right hand 60 is measured to obtain a displacement value, and a command for moving the cursor displayed on the display according to this displacement value is input, so as to move the cursor displayed on the display. The method for measuring the displacement of the index finger 62 of the right hand 60 is, for example, comparing the positions of the index finger 62 of the right hand 60 at different time points, so as to obtain the displacement value.

If the image capturing device captures images in which the left hand 50 makes a first and the right hand 60 also makes a first (as shown in FIG. 3B), a command for locking the cursor displayed on the display is input, so as to lock the cursor.

If the image capturing device captures images in which the left hand 50 makes a first and the right hand 60 sticks out a thumb 64 (as shown in FIG. 3C), a command for clicking the left button of the mouse is input, so as to execute functions of the left button of the mouse.

If the image capturing device captures images in which the left hand 50 makes a first and the right hand 60 sticks out a little finger 66 (as shown in FIG. 3D), a command for clicking the right button of the mouse is input, so as to execute functions of the right button of the mouse.

If the image capturing device captures images in which the left hand 50 sticks out an index finger 52 and the right hand 60 makes a first (as shown in FIG. 3E), a command for turning to a previous page or turning to a next page according to up or down movement the right hand 60 is input, so as to execute a function of turning to the previous page or turning to the next page.

If the image capturing device captures images in which a left hand 50 sticks out the index finger 52 and a middle finger 54 and the right hand 60 sticks out the index finger 62 (as shown in FIG. 3F), the displacement of the index finger 62 of the right hand 60 is measured to obtain a displacement value, and a command for inputting a character according to this displacement value is input, so as to execute a function of inputting the character. The method for measuring the displacement of the index finger 62 of the right hand 60 is, for example, comparing the positions of the index finger 62 of the right hand 60 at different time points, so as to obtain the displacement value.

Therefore, when the user desires to move the cursor displayed on the display, the left hand 50 may make a first and the right hand 60 may stick out the index finger 62 (as shown in FIG. 3A), so as to move and control the cursor through movement of the index finger 62 of the right hand 60. When the left hand 50 and the right hand 60 of the user both make fists (as shown in FIG. 3B), the cursor is locked. When the left hand 50 of the user makes a first and the right hand 60 of the user sticks out the thumb 64 (as shown in FIG. 3C), the function of the left button of the mouse is executed. When the left hand 50 of the user makes a first and the right hand 60 of the user sticks out the little finger 66 (as shown in FIG. 3D), the function of the right button of the mouse is executed. When the user desires to execute the function of turning pages, the left hand 50 may stick out the index finger 52 and the right hand 60 may make a first (as shown in FIG. 3E), so that the function of turning to the previous page or turning to the next page by up or down movement of the right hand 60. When the user desires to execute a function of inputting a character, the left hand 50 may stick out the index finger 52 and the middle finger 54 and the right hand 60 may stick out the index finger 62 (as shown in FIG. 3F), so as to execute the function of inputting the character through movement of the index finger 62 of the right hand 60. In FIG. 3F, the user inputs a character “a” by, for example, movement of the index finger 62 of the right hand 60.

It should be noted that the movements of the hands shown in FIGS. 3A to 3F are only used as examples; the invention is not thereby limited. In other words, according to other embodiments, the user may use other kinds of movements of the hands to output the commands which execute the above functions by configuring the software or firmware.

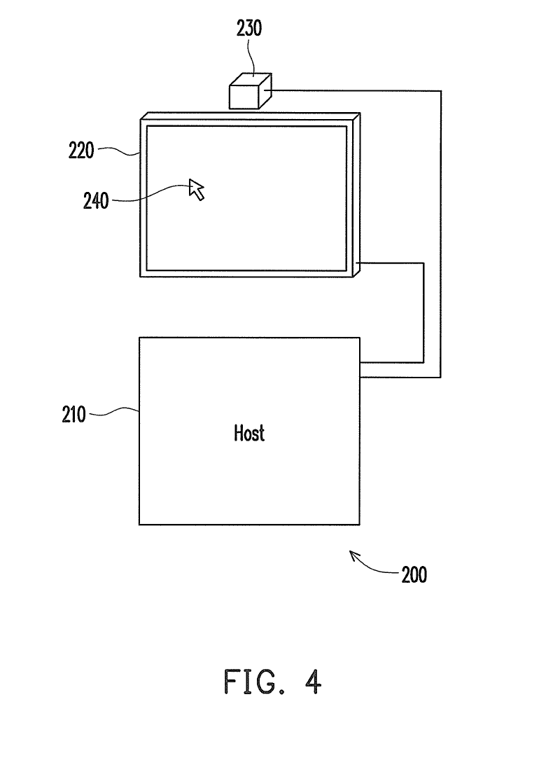

FIG. 4 is a diagram illustrating a computer according to still another embodiment of the invention. Referring to FIG. 4, the computer 200 includes a host 210, a display 220 electrically connected with the host 210, and a capturing device 230 also electrically connected with the host 210.

The image capturing device 230 can capture a hand image of a human body in two-dimensional image form, the host 210 can determine a shape of the above hand image in two-dimensional image recognition to obtain a determined result, and the host can generate a command according to the above determined result for controlling a cursor 240 displayed on the display 220, wherein the host 210 may also have a computer operating system installed therein, and the computer operating system may be capable of creating the cursor 240.

Specifically, the host 210 can compare the hand images at different time points to obtain a displacement value for adding to the determined result, and the cursor 240 displayed on the display 220 is moved according to the displacement value.

In the present embodiment, the host 210 may be a host of a desktop computer or a host of a notebook computer. The host 210 and the display 220 may be integrated as a single unit or may be two individual parts. The image capturing device 230 is a built-in component or an external component with respect to the display 220.

In summary, according to the above embodiments of the invention, the human body images are captured by the image capturing device, and the commands are generated according to the determined results of the human body images, so that the user is able to input the commands without contacting the keyboard, mouse, or touch pad. Further, the user is able to use the movements of the hands to control various functions of the mouse and keyboard, so that an input method different from conventional technology is provided.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A command generation method, comprising:
capturing a human body image by an image capturing device of a computer in a two-dimensional image form, wherein the image capturing device is a built-in component or an external component with respect to the computer, and wherein the computer is a desktop computer or a notebook computer, and the desktop computer includes a host and a display that are electrically connected with each other and integrated as a single unit or are two individual parts;
determining a shape of the human body image in two-dimensional image recognition to obtain a determined result; and
generating a command according to the determined result.

2. The command generation method of claim 1, wherein the human body image comprises a left hand image and a right hand image, and when determining the shape of the human body image, individually determining a shape of each of the left hand image and the right hand image to obtain two determined values, the determined result comprising the two determined values.

3. The command generation method of claim 1, further comprising:
comparing the human body images at different time points to obtain a displacement value for adding to the determined result, wherein the command is a command of moving a cursor displayed on the display according to the displacement value.

4. The command generation method of claim 1, wherein the command is a command of clicking a right button of a mouse.

5. The command generation method of claim 1, wherein the command is a command of clicking a left button of a mouse.

6. The command generation method of claim 1, wherein the command is a command of turning pages.

7. The command generation method of claim 1, further comprising:
comparing a plurality of human body images captured at different time points to obtain a displacement value, wherein the command is a command of inputting a character according to the displacement value.

8. A command generation method, comprising:
capturing a hand image of a human body by an image capturing device of a computer in a two-dimensional image form;
determining a shape of the hand image in two-dimensional image recognition to obtain a determined result; and
generating a command according to the determined result for controlling a cursor displayed on a display of the computer.

9. The command generation method of claim 8, wherein the image capturing device is a built-in component or an external component with respect to the computer, and wherein the computer is a desktop computer or a notebook computer, and the desktop computer includes a host and a display that are integrated as a single unit or are two individual parts.

10. The command generation method of claim 8, further comprising:
comparing the hand images at different time points to obtain a displacement value for adding to the determined result, wherein the cursor is moved according to the displacement value.

11. A computer, comprising:
a host being a host of a desktop computer or a host of a notebook computer;
a display electrically connected with the host; and
a capturing device electrically connected with the host;
wherein the image capturing device is capable of capturing a hand image of a human body in two-dimensional image form, the host is capable of determining a motion of the hand image in two-dimensional image recognition to obtain a determined result, and the host is capable of generating a command according to the determined result for controlling a cursor displayed on the display.

12. The computer of claim 11, wherein the host is capable of comparing the hand images at different time points to obtain a displacement value for adding to the determined result, and the cursor displayed on the display is moved according to the displacement value.

13. The computer of claim 11, wherein the host has a computer operating system installed therein, and the computer operating system is capable of creating the cursor.

14. The computer of claim 11, wherein the host and the display are integrated as a single unit or are two individual parts.

15. The computer of claim 11, wherein the image capturing device is a built-in component or an external component with respect to the display.
